(19) United States
(12) Patent Application Publication
(10) Pub. No.: US 2002/0160114 A1
(43) Pub. Date: Oct. 31, 2002

(54) Method of manufacturing decorative wood products from engineered wood products

(76) Inventor: Michael Cozzolino, Lebanon, NJ (US)

Correspondence Address: Michael R. Friscia, Wolff & Samson, 5 Becker Farm Road, Roseland, NJ, 07068-1776, US

(21) Appl. No.: 10/113,050

(22) Filed: Apr. 1, 2002

Related U.S. Application Data
(63) Continuation-in-part of application No. 09/566,158, filed on May 5, 2000, now Pat. No. 6,428,871.

(51) Int. Cl. B05D 5/00

(52) U.S. Cl. 427/256

(57) ABSTRACT

The present invention relates to a method for forming a decorative, resilient, wood product from an engineered structural wood product. The invention includes utilizing a sheet of engineered structural wood product, cutting the sheet lengthwise into planks, stacking the planks and adhering the planks together and slicing the edge grain off the adhered planks and placing the slices side-by-side to form large areas of exposed side grain. Alternatively, the slices can be cut directly from the engineered structural wood product. The slices can be used directly or attached to a substrate. The slices can be further treated to produce a decorative wood product. Additives can be introduced to the engineered structural wood product during the manufacture thereof to incorporate decorative elements therein which are made visible by slicing the wood product to expose edge grain.

### RELATED APPLICATION

This application is a continuation-in-part application of U.S. patent application Serial No. 09/566,158, filed May 5, 2000, now U.S. Pat. No. ______, dated ______, by Michael Cozzolino, entitled Method of Manufacturing Decorative Wood Products from Engineered Wood Products, the entire disclosure of which is expressly incorporated herein by reference.

### BACKGROUND OF THE INVENTION

1. Field of the Invention

The present invention relates to a method of manufacturing decorative wood products from engineered structural wood products, and more particularly, to a method of creating a decorative product with an exposed side grain from an engineered structural wood product.

2. Related Art

It has long been known to expose wood grain for decorative purposes. Indeed, flooring, walls (paneling) and even furniture including such things as tables, desks, etc., often display wood grain for decorative purposes. The wood grain gives a nice texture and design to the surface of the decorative wood product. Sometimes the effect of wood grain is obtained through the use of veneers which can be arranged and manipulated to present wood grain designs.

It is also known that the end grain of wood presents a nice design and provides a very resilient surface that makes it desirable for use in flooring. Numerous previous patents disclose methods, and products made by such methods, for creating decorative wood products that feature wood grain. These efforts include the following patents:

Green, U.S. Pat. No. 329,828, which discloses wooden flooring and wainscoting for providing highly ornamental flooring that is durable and free from liability to become disfigured by constant wear or contact therewith of hard substances. The flooring includes blocks of uniform shape and size each having a central piece surrounded by side pieces forming borders about the central piece. The central piece and the side pieces each have the end grain running in a different direction from that of the others while the length of the grain stands at an angle of 45 degrees to the plane of the surface. The side pieces are attached to the central portion by glue prior to cutting and then the whole composite is cut through diagonally. The patent indicates that the flooring is durable because the inclination of the grain at about 45 degrees from horizontal is the best position for resisting wear.

Marino, U.S. Pat. No. 3,365,850, discloses dimensionally stable wood flooring constructed of wood fillets having limited width. Each fillet is adhered to adjacent fillets by materials that absorbs dimensional changes in the contiguous fillets.

Severson, et al., U.S. Pat. No. 5,322,584, discloses a method of making wooden tile wherein each block contains at least one lateral groove extending parallel to and spaced inwardly from the edges of the block and at least one longitudinal groove extending parallel to and spaced inwardly from the side edges of the block and intersecting the lateral groove at a right angle. When the blocks are aligned in abutting relationship, the grooves form a grid-like network of continuous, rectilinear channels which can be filled with a flowable synthetic plastic material which can then be cooled to bond the wood together.

Chase, U.S. Pat. No. 5,182,892, discloses a tongue and groove board product where the tongue has at least one vertically extending opening which allows for a drain path for water to drain from the surface.

Jensen, U.S. Pat. No. 3,730,797, discloses parquet building boards. The narrow faces are secured to a flat base and the grain runs parallel to the base.

King, U.S. Pat. No. 3,282,010, discloses a parquet flooring block formed from a plurality of squares. A mechanical connecting means eliminates the need for adhesives.

Tibbals, U.S. Pat. No. 3,128,511, discloses parquet flooring block wherein the wooden slats are secured together by one or more wires recessed in the under-surface of a block.

Elmendorf, U.S. Pat. No. 2,118,841, discloses flexible end grain wood floor covering using a comparatively thin layer of wood. The wood is sliced and then split and then placed closely together and glued to the underlying floor to prevent warping of entire sheets.

Murphy et al., U.S. Pat. No. 2,037,259, discloses wood flooring comprising a plurality of thin layers of wood joined together by alternately placing side by side a layer of end grain wood and a layer of side grain wood to provide maximum wearing qualities and strength, respectively. The layers are adhered together and then can be glued down to form a surface.

Elmendorf, U.S. Pat. No. 1,931,650, discloses a floor covering comprised of a plurality of small blocks or tiles having a binding material therebetween to form a floor covering. The wooden blocks may show end grain.

Dunton, U.S. Pat. No. 1,078,776, discloses wood flooring in which the end grain is presented in small blocks or sections joined together. Essentially planks of wood are stacked, sliced to present end grain, sliced again for sizing, and then the sides are detailed for attachment of the strips together.

Fulton, U.S. Pat. No. 1,028,703, discloses a wooden floor covering. The flooring is created by cementing a number of slabs of wood together to form a composite. The composite is sliced and then cemented together to form a compound block.

Piver, U.S. Pat. No. 598,437, discloses composite flooring having an exposed edge grain.

Murch, U.S. Pat. No. 451,834, discloses a method of cutting wood for ornamental purposes by obliquely cutting through a piece of wood with the bark on the wood and then shaping the piece by removing bark.

Koskul, U.S. Pat. No. 436,041, discloses ornamental wood working by forming piles of wood from which veneers, slabs and blocks may produced which present the end grain of the wood which are sawed or cut from the respective pilings.

Hamilton, U.S. Pat. No. 108,781, discloses a tessellated floor made up of blocks of wood arranged to show the end grain. Portions may be cut out of the blocks into geometric shapes and filled with wood plugs to create designs.

It has also been known, in the past, to utilize materials other than natural wood product to create floors and other decorative or useful wood products from other natural materials and from synthetic materials. However, often times, synthetic materials cannot provide the warmth, texture or richness of wood products. Although efforts may be made to attempt to infuse “wood” characteristics into a synthetic material, such efforts heretofore have not been generally successful. Some work in the area of using wood product or synthetic materials include the following:

Kaswell, U.S. Pat. No. 3,887,736, discloses a synthetic end grain block defining a wear surface. The block has a top surface, a bottom surface parallel to the top surface and a peripheral surface connecting the top and bottom surfaces. The block comprises a plurality of wear fibers extending therewithin substantially perpendicular to the top and bottom surfaces, and an organic plastic material binding the fibers together. The blocks include a plurality of wear fibers that may be natural or synthetic. Synthetics include rayon, acetate, protein, nylon, polyester, acrylic, olefin, glass, modacrylic, saran, tetrafluorethylene, vinyon, vinyl, nytril, polystyrene, rubber, spandex and extruded monofilaments. Natural materials include cotton, line, jute, abaca, sisal, rubber and henequen. Normally, the blocks are impregnated with a resin such as phenol formaldehyde, resorcinol formaldehyde, alkyd, polyamide, epoxy, and polyester.

Blackburn, U.S. Pat. No. 3,905,172, discloses a method of laying wooden floors by placing preformed groups of end cuts of timber on a base and pouring adhesive between the groups of end cuts and polishing the hardened surfaces of the floor to expose the cross grain of the timber. The groups of end cuts are formed by securing lengths of timber together in a bundle, adhering them together, and cross cutting the bundle into slices.

Pittman, U.S. Pat. No. 3,810,774, discloses a wall panel that resembles an actual wood plank having an outer decorative surface which is printed and decorated to resemble a wood plank. The printing is done step wise, first the wood undertone is printed, then a pattern is printed and then finely defined details of the wood grain are printed. Each printing is done in a different color and the final result resembles the appearance of actual wood planks.

Barrett, U.S. Pat. No. 3,579,410, discloses prefinished parquet flooring impregnated with a monomer that is polymerized to have a high resistance to abrasive wear.

Bernett, U.S. Pat. No. 3,209,500, discloses a wooden base covered with tile. Ceramic is bonded to the wood and substrate with epoxy resin.

It is also known that structural wood products can be engineered effectively for use as structural components such as for the core of doors, etc. Engineered structural wood products are also known as “structural composite lumber” or “SCL.” One such engineered structural wood product is manufactured and sold by Trus Joist MacMillan under the trademark TimberStrand. TimberStrand is made by using small trees from a wide variety of species, cleaning and debarking the trees and cutting same into strands up to twelve inches long, drying the strands and coating the strands with a formaldehyde-free adhesive. The coated strands are then aligned parallel to each other to take advantage of the natural strength of the wood and passed through a steam injection pressing process which laminates the strand into solid billets of wood up to four and a half inches thick. The billets can then be cut to specification. The primary known use for such engineered wood product is as structural composite lumber for use in the core of wood doors, because it combines the screw holding and bending properties of lumber with the engineered stability of a particleboard core. One benefit of this structured wood product is that small trees can be used and the demand is lessened for harvesting trees from valued and protected old growth forests. However, one drawback with the engineered lumber is that it is not decorative as formed, i.e. the faces of the finished product are not decorative.

What would be desired, but has not yet heretofore been developed, is to provide a process wherein an engineered wood product could be made into a decorative wood product to take advantage of the structured wood product features, while providing a decorative end product.

### OBJECTS AND SUMMARY OF THE INVENTION

It is a primary object of the present invention to process engineered wood products, such as SCL, into decorative wood products.

It is a further object of the present invention to provide a method for creating a decorative wood product from an engineered wood product.

It is another object of the present invention to provide a decorative wood product which presents a side grain or edge from an engineered wood product.

It is even another object of the present invention to provide a decorative wood product which accentuates side or edge grain features of an engineered wood product.

It is a further object of the present invention to provide an inexpensive decorative wood product.

It is even a further object of the present invention to provide a resilient decorative wood product from a engineered wood product, that can be used for flooring or for any other desired purpose.

The present invention relates to a method for forming a decorative, resilient, wood product from an engineered structural wood product. The invention includes utilizing a sheet of engineered structural wood product, cutting the sheet into planks, stacking the planks and adhering the planks together, slicing the adhered planks to present the side or edge grain, and placing the slices side-by-side to form large areas of wood product with exposed side grain. The slices can be attached to a substrate for use in any desired manner. The slices can be further treated to produce a decorative effect.

In another embodiment, a decorative wood can be formed directly from a sheet of engineered wood product by slicing the sheet to present the side or edge grain. These slices can be used directly or attached to a substrate. These slices can be edged glued to form a sheet of a desired width. The thickness of the engineered wood product can be varied to create slices of desired widths. The slices can be further treated to produce a decorative effect. A decorative effect can also be achieved by treating the engineered wood product prior to or during the formation thereof.

### BRIEF DESCRIPTION OF THE DRAWINGS

Other important objects and features of the invention will be apparent from the following Detailed Description of the Invention taken in connection with the accompanying drawings in which:

FIG. 1 is a perspective view of a sheet of engineered structural wood product.

FIG. 2 shows the sheet of structural wood product of FIG. 1 cut into planks having a similar width.

FIG. 3 shows the planks of FIG. 2 positioned in a stack.

FIG. 4 shows a slice off of the stack shown in FIG. 3.

FIG. 5 shows a plurality of slices of FIG. 4, lined up to form a surface of exposed side or edge grain.

FIG. 6 shows an example of a decorative wood product manufactured in accordance with the present invention.

FIG. 7 is a perspective view of a sheet of engineered wood product with a slice presenting side or edge grain.

### DETAILED DESCRIPTION OF THE INVENTION

The present invention relates to a method of manufacturing decorative hard wood products from an engineered structural wood product such as SCL. This invention utilizes a series of manufacturing steps to expose the side grain of the engineered structural wood product to create a decorative wood product that includes the structural advantages, such as stability, of the engineered structural wood product.

Referring to FIG. 1, the present invention starts out with a sheet of engineered structural wood product, which is generally indicated at 10. One such product, as previously set forth, is known as Timberstrand, and is manufactured by Trus Joist. The sheet billet is manufactured to any desired dimensions such as 16 feet by 35 feet. It is then cut to a desired dimension. A typical dimension is four feet by ten feet by one and three quarters inch. The top surface 12, and the bottom surface are generally unattractive and represent visually the pieces (strands) on the flat. However, if properly processed, the edge grains 14, can provide an appealing looking surface. The present invention is designed to take advantage of the appealing side grain 14 by exposing same.

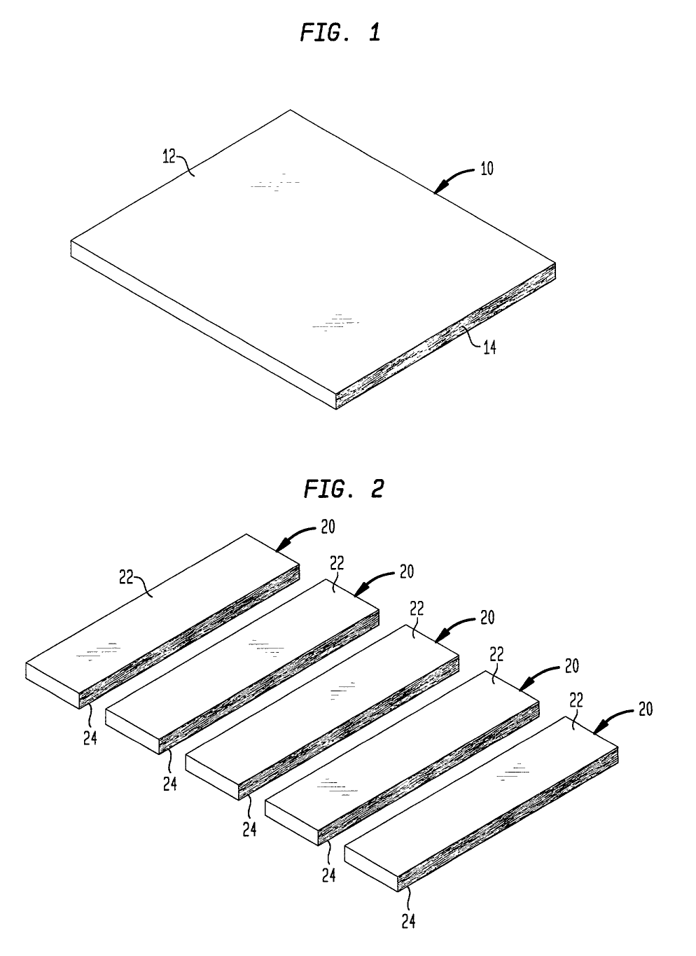

Referring to FIG. 2, the sheet 10 is cut up into planks 20 each having a top surface 22 and exposed side grain 24. It is preferable to cut the sheets into substantially equal sizes. A preferable size is eight inches by ten feet by one and three quarters of an inch. However, this can be varied as desired.

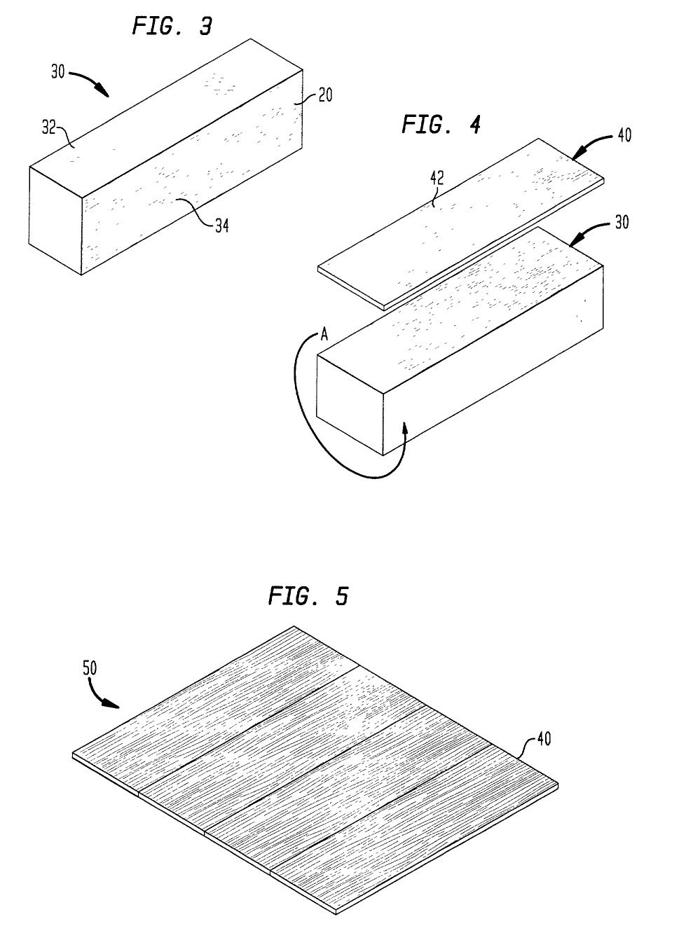

Thereafter, as shown in FIG. 3, the planks 20 are placed on the other to form a stack. The stack has a top 32 and an exposed edge grain 34 and end grain 34a. The stacked planks are then laminated together to create a formed stack 30. As is generally known, the lamination process can be performed in a hot platen press, such as for example at 42 P.S.I. utilizing a catalyzed glue line, to create a strong and waterproof bond between the planks 20. One such press is a Hofer Veneer press. It has been found that 42 P.S.I. for 30 minutes provides a sufficient bond between the planks 20. It should be noted that a number of stacks of planks can be pressed into formed stacks in a single operation. Radio frequency pressing equals shorter cycles.

Referring now to FIG. 4, it can be seen that the formed stack 30 can be rotated as shown by arrow A and sliced into sheets 40 have an exposed edge grain along the upper surface 42. The formed stacked 30 can be sliced into numerous sheets 40 of whatever thickness is desired. For example, it has been found that half inch thick sheets 40 which measure one half inch by eight and three quarters of an inch by ten feet, are a suitable size for utilization of the sheets 40 as a decorative wood product side-by-side and made into larger pieces for panels, moldings, furniture, etc. Frame saws, such as manufactured by Wintersteiger and Ogden Enterprises, greatly facilitate the sheet cutting by cutting multiple sheets at one time.

As shown in FIG. 5, the sheets 40 can be positioned side-by-side to form a large area of decorative wood product 50. Importantly, when placed side by side, sheets 40 form a large area of decorative wood product 50 wherein the seams between sheets 40 are not visible. Preferably the sheets 40 can be laminated to various substrates, such as Luan plywood. The lamination process could take place in a hot press. The Luan is typically four feet wide and can be busted up into four and a quarter inch sticks and can be machined so that they can be interconnected by means of a tongue and groove, as is known in the industry.

Further, the sheets 40 can be utilized, as desired, to form any decorative wood product, including, but not limited to, panels, moldings, furniture, etc.

Importantly, it may be desirable to treat the exposed side grain of the decorative wood product 50. First, a planar may be used to preliminarily finish the surface. A planar is essentially an aggressive sander which will provide a generally smooth surface to the decorative wood product 50. The planar can be followed-up with another sander until the floor is suitably smooth. Thereafter, the decorative wood product 50 can be finished with a polyurethane floor finish to which it may be desirable to add a catalyzer. Thereafter, the surface can be installed as it is known to install any wood floor.

Further, the decorative wood product 50 can be finished with a stain, such as a translucent stain or a clear coat with a two component urethane floor finish. Again, the product can be finished in accordance with what is known in the industry.

For creating interesting effects, a wire wheel brush can be used to open up the porous surface, and then the grooves can be refilled with various desired materials, which could have various desired colors. Examples of such materials include wood floor fillers, pigmented polyesters, and liquid or solid epoxy compounds. Then, the decorative wood product could be sanded again and urethaned to create effects and utilize colors to obtain different styles of wood product. One such design could be a straight chisel look wherein grooves are “chiseled” into the wood product and the grooved wood product could be re-filled to highlight the chiseled effect.

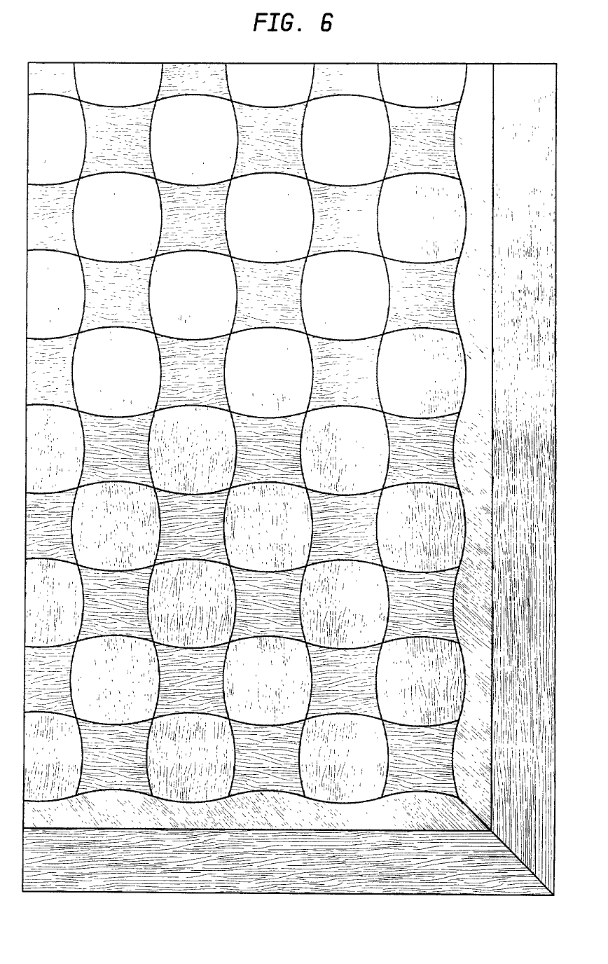

FIG. 6 is one example of a decorative wood product finished according to the present invention. As can be seen, the floor can be patterned, or alternatively, can be formed having an overall appearance of side grain without boundaries between adjacent planks.

To create wall or ceiling panels, the eight inch sheets can be edge glued together to create the size sheet needed, and also laminated to various substrates. The surface can be finished in a similar manner as the floor, and can be wire brushed to create a visually interesting, strongly textured surface.

The density of the engineered material allows it to be carved and machined and molded into furniture. However, the finishing of the furniture before sanding generally requires the coating of the surface with wood filler, pigmented polyesters and/or liquid or solid epoxy compounds. The furniture is then sanded down to the original wood for a completely smooth surface. Pieces can then be finished in a manner appropriate to use.

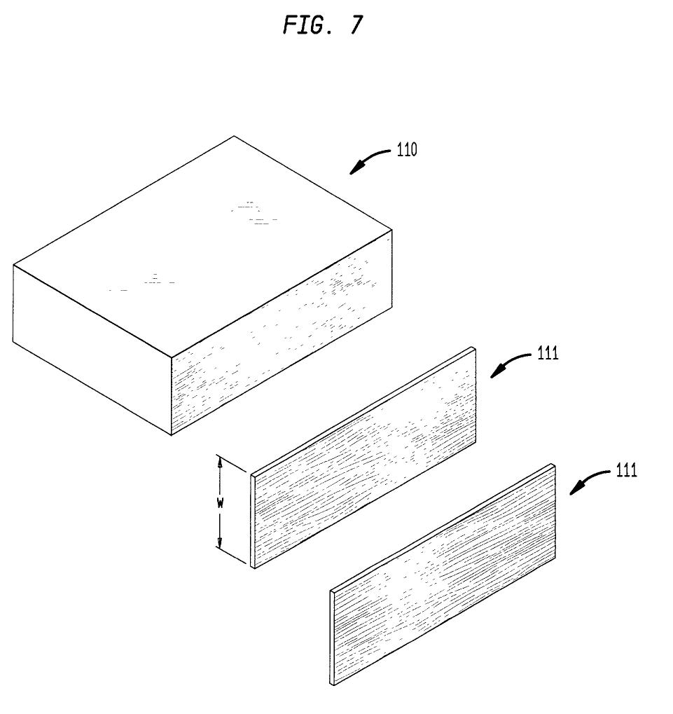

Referring to FIG. 7, it can be seen that one could slice the engineered wood product 110 directly to form slices 111 showing a side or edge grain. This direct forming allows decorative wood product to be created without cutting the engineered wood product into planks, stacking and adhering the planks and subsequently slicing the planks. The size of the slices 111 can be varied in thickness as desired. The width of the slice w can be varied by varying the thickness of the starting product 110. The slices 111 can be used directly or attached to a substrate. Likewise, the slices 111 could be edge glued to form a larger area decorative wood product. Slices three inches or less in width can be used for strip flooring, and slices of three inches or greater in width can be used for plank forming. Currently, it is known to form engineered wood products up to about four and a half inches thick. Numerous slices can be created simultaneously through resawing the engineered wood product into slices 111. The slices 111 can then be backed for stability and integrity and used as planks to run through flooring lines to side and end match thereby producing plank or strip flooring directly from engineered wood product 110 without stacking and resawing.

The slices 111 or sheets 40 produced in accordance with the present invention can be treated in numerous ways to create a decorative finish and/or to enhance the decorative finish thereof.

For example, during the formation of the engineered wood product, additives can be used to create an engineered wood product that has decorative features contained therein. One way to introduce features is to use a decorative wood species in the manufacture of the engineered wood product. Cherry, walnut, mahogany or other wood can be cut up into strands and added to the conventional strands (typically an Aspen mix) forming the engineered wood product so that after the pressing process, an engineered wood product is created with decorative wood species contained therein. This could result in desirable shades and/or colors in the finished product. By including such decorative wood species into the engineered wood product the added decorative color will remain unchanged from refinishing and/or wear.

Other efforts can be made to build decorative features into the engineered wood product. For example, some or all of the strands comprising the engineered wood product can be dyed prior to creating the wood product to add a color or shade into the engineered wood product. Likewise, a colored glue could be used to impart a color or shade to the engineered wood product. This could produce a veined or variegated look to the final product. Other products could be added to the engineered wood product. For example, the veneer industry produces significant wood waste, typically from decorative woods, and this waste could be added to the engineered wood product prior to the formation thereof to add interesting and unique effects or patterns to the structural wood product. In addition, components other than strands could be added to the engineered wood product to also create interesting effects. While strands are used for forming the structure of the wood product, squares or plugs or other shapes, either purposefully formed or formed as a by-product of another process, could add special effects.

Slices or sheets 40 could also be treated by acrylic and color impregnation of the face wear layer of the resawn product. For example, PermaGrain Products, Inc., Newtown Square, Pennsylvania, has a process for acrylic and color impregnation of wood which it sells under the PermaGrain trademark. This process can be applied to the sheets or slices to color and impregnate them.

Having thus described the invention in detail, it is to be understood that the foregoing description is not intended to limit the spirit and scope thereof. What is desired to be protected by Letters Patent is set forth in the appended claims.

What is claimed is:

1. A method of forming a decorative wood product from an engineered structural wood product formed of a plurality of cut wood strands aligned and adhered together, the method comprising:
providing an engineered structural wood product formed of wood strands, the product having an edge grain formed by the strands; and
slicing the engineered structural wood product into a plurality of sheets having edge gains formed by the strands.

2. The method of claim 1 further comprising attaching the sheets with exposed edge grain formed by the strands to a substrate.

3. The method of claim 1 further comprising finishing the exposed side grain of the sheets by sanding.

4. The method of claim 3 further comprising the step of coating the finished edge grain with a translucent protective covering.

5. The method of claim 4 wherein the covering is urethane.

6. The method of claim 2 wherein the substrate is formed into a tongue and groove configuration for installation as flooring.

7. The method of claim 1 further comprising edge gluing the sheets with exposed edge grain to form a large sheet of material with exposed edge grain.

8. The method of claim 7 farther comprising adhering the large sheet to a substrate.

9. The method of claim 1 further comprising finishing the edge grain by wire brushing.

10. The method of claim 9 further comprising filling grooves formed by wire brushing with a colored material to provide a decorative effect.

11. The method of claim 1 further comprising finishing the sheets by acrylic impregnation of the sheets.

12. The method of claim 1 further comprising varying the width of the sheets by varying the thickness of the engineered wood product.

13. A method of forming a decorative wood product from an engineered structural wood product comprising:
cutting wood into strands;
coating the strands with an adhesive;
aligning the strands;
applying heat and pressure to the strands to form an engineered structural wood product, the product showing side grain of the wood product formed by the strands; and
cutting the engineered structural wood product into planks to successively expose the side grain formed by the strands of the product.

14. The method of claim 13 further comprising adding decorative elements to the wood strands prior to applying heat and pressure to form an engineered wood product with decorative features.

15. The method of claim 14 wherein the step of adding decorative elements to the wood strands comprises adding strands of a decorative wood species to the wood product.

16. The method of claim 15 wherein the step of adding decorative elements comprising dying some of the strands prior to forming the decorative wood product.

17. The method of claim 15 wherein the step of adding decorative elements comprises dying all of the strands.

18. The method of claim 17 wherein the step of adding decorative elements comprises adding waste wood products.

19. The method of claim 18 wherein the waste wood products come from decorative woods.

20. The method of claim 19 wherein the waste wood is generated from the veneer industry.

21. The method of claim 19 wherein the waste wood products comprise odd shapes.

22. The method of claim 21 wherein the odd shapes are squares, plugs or other shapes.

23. The method of claim 14 wherein the step of adding decorative elements comprises using colored glue.

24. A decorative wood product formed from an engineered structural wood product formed of a plurality of cut wood strands aligned and adhered together comprising:
an upper surface presenting a side grain formed by the wood strands; and
a lower surface attachable to a substrate.

25. The decorative wood product of claim 24 wherein the upper surface is finished by sanding and clear coating.

26. The article of claim 25 wherein the upper surface is decorated by gouging and refilling with desired materials.

27. The article of claim 24 wherein the upper surface is finished by acrylic impregnation.

28. The article of claim 24 wherein cut wood strands from a decorative wood species are included in the engineered structural wood product to form a decorative wood product.

29. The article of claim 24 wherein a colored glue is used in the engineered structural wood product to form a decorative wood product.
